(19) United States
(12) Patent Application Publication
(10) Pub. No.: US 2003/0052483 A1
(43) Pub. Date: Mar. 20, 2003

(54) Repositional write-on transparency

(76) Inventor: Kevin Charles McLean, San Diego, CA (US)

Correspondence Address: NEIL K. NYDEGGER, NYDEGGER & ASSOCIATES, 348 Olive Street, San Diego, CA, 92103, US

(21) Appl. No.: 10/226,257

(22) Filed: Aug. 22, 2002

Related U.S. Application Data
(60) Provisional application No. 60/322,707, filed on Sep. 17, 2001.

(51) Int. Cl. B42D 15/00

(52) U.S. Cl. 283/107

(57) ABSTRACT

A device for highlighting text on a page includes a flat base member having an adhesive affixed to one of its sides for temporarily holding the base member against the page. A marker can then be used to highlight selected text by depositing a translucent ink on the base member as it is held against the page. Also, the base member can be provided with a clear coating, on the side opposite the adhesive, that will act to dry the ink and retain a residue thereof over the selected text. After use, the device can be lifted and removed from the page without altering the page.

This application claims the benefit of U.S. Provisional Application No. 60/322,707 filed on Sep. 17, 2001.

### FIELD OF THE INVENTION

The present invention pertains generally to systems and methods for selectively placing reference marks on certain informational materials. More particularly, the present invention pertains to systems and methods for highlighting certain portions of textual material for reference purposes. The present invention is particularly, but not exclusively, useful for systems and methods wherein highlighting on textual material can be removed or repositioned without adversely affecting or otherwise altering the underlying textual material.

### BACKGROUND OF THE INVENTION

There are many instances when it may be necessary or desirable to mark textual material in some manner. Perhaps the most obvious example of such an instance involves a student who is studying from a schoolbook. As the student reads the material, he/she typically comes upon passages or phrases which may be of particular interest, and that the student may wish to mark for future reference. Further, for a given book, different passages or phrases will have different value for different students. Thus, the marking of textual material is essentially a matter of individual preference.

Heretofore, several methods and devices have been employed to mark text or locations in books and other compilation of written or printed material. For general reference purposes, these devices include such well-known objects as book marks and ribbons. For more detailed marking of textual material, however, it has been necessary to actually alter the page of the book to thereby somehow highlight the reference. For example, underlining text with a pen or pencil, inserting marginal notes, and directly highlighting text with see-through inks have been widely used methods for marking certain informational material. The consequence, however, is that in each of these cases the page of text is irreversibly altered by the marking. This may be undesirable.

When books are resold or used by another reader, or even when they are being reviewed by the same reader, previously made markings on the pages of a book may be distractive, unwanted, or otherwise diminish the value of the book. On the other hand, it is clear that the ability to mark or highlight phrases or passages in textual material can be of great benefit to a reader.

In light of the above, it is an object of the present invention to provide devices and methods for marking and highlighting specific text for subsequent review and future reference. Another object of the present invention is to provide devices and methods for marking and highlighting specific text without damaging or permanently altering the substratum on which the text is written or printed. Still another object of the present invention is to provide devices and methods for marking and highlighting specific text that are permanent while in use, but which can be selectively removed from or repositioned on the text. Yet another object of the present invention is to provide devices and methods for marking and highlighting text that are simple to use, relatively easy to manufacture, and comparatively cost effective.

### SUMMARY OF THE PREFERRED EMBODIMENTS

In accordance with the present invention, an overlay device is provided for temporarily highlighting certain informational markings on a substratum, such as textual material in a book. Specifically, the overlay device of the present invention includes a substantially transparent, rectangular-shaped base member. The opposed sides of the base member are substantially flat, parallel surfaces, with a thickness between the surfaces that is in a range between one half and three millimeters (0.5 mm-3 mm). The dimensions of the surfaces of the base member can vary, but they will preferably be such that the overall size of the overlay device will be greater than approximately three inches by three inches (3 in.×3 in.).

A strip of adhesive is affixed to a portion of the surface on one side of the base member. Preferably, the adhesive will extend across this surface of the base member from one edge to another with a width in a range of approximately one quarter inch to one half inch (¼ in.-½ in.). The surface on the other side of the base member is completely covered with a coating.

Importantly, the base member, the adhesive, and the coating, together in their combination as the overlay device of the present invention, are flexible and substantially transparent. With this in mind, the base member is preferably made of a material such as an acetate, a polypropylene or a polyester. The coating is preferably made of a material such as an acrylic, urethane, polyester or saran. And, the adhesive is preferably a microsphere acrylic adhesive.

In the operation of the system and method of the present invention, the overlay device is positioned over a particular part of a substratum, such as a paragraph on a page of a book. The adhesive on the base member is then engaged with the substratum to temporarily hold the overlay against the substratum (e.g. book page). A marking pen, such as a so-called “highlighter”, is then used to deposit a liquid substance, such as a translucent ink, over selected portions of the coating on the overlay. The result here is that certain informational material underlying the overlay is highlighted. For this purpose, the coating needs to be interactive with the liquid substance (i.e. ink) in a way that will allow the ink to dry, and restrain the dried residue of the liquid substance to the selected portions of the overlay. In this manner, the certain informational material of interest will be highlighted when, but only when, the overlay device is held against the substratum.

It is an important aspect of the present invention that once the overlay device has been positioned, and held against a substratum, it can be easily removed and repositioned, if desired. Further, it is important that whenever an overlay device is removed from a substratum, neither the substratum nor the informational material on the substratum is adversely affected or otherwise altered in any way.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an open book with the overlay of the present invention positioned on a page;

FIG. 2 is a cross sectional view of the overlay device of the present invention as seen along the line 2-2 in FIG. 1; and

FIG. 3 is a side elevation view of a marking pen for use with the present invention.

### DESCRIPTION OF THE PREFERRED EMBODIMENT

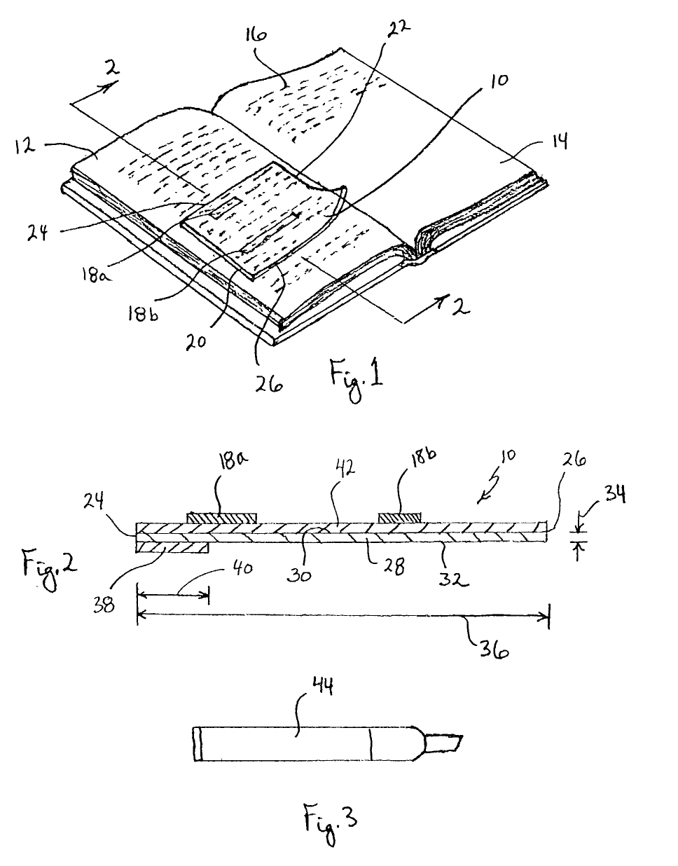

Referring initially to FIG. 1, an overlay device in accordance with the present invention is shown and designated 10. As shown, the overlay device 10 is being held on a page 12 of a book 14. More specifically, the overlay device 10 is positioned over textual material (text) 16 that has been written or printed onto the page 12. For purposes of the present invention, it is to be appreciated that the page 12 is merely exemplary of many types of substrata on which the informational material of the text 16 may be written, printed or otherwise presented. Further, it is to be appreciated that the printed text 16 shown in FIG. 1 is only exemplary. As envisioned for the present invention, the textual material (text) 16 may, in fact, be pictures, graphs, tables or any other type of presentation of informational material presently known.

FIG. 1 also indicates that the overlay device 10 may include highlight markings 18, of which the highlight markings 18a and 18b are only exemplary. Importantly, these highlight markings 18 are made on the overlay device 10, and not on the page 12. FIG. 1 further indicates that the overlay device 10, although normally flat, has a degree of flexibility that allows it to be slightly bent for purposes of positioning the overlay device 10 on, and removing it from, the page 12. Although the actual dimensions of the overlay device 10 can vary, it will preferably be rectangular shaped, with opposite sides defined by the edges 20 and 22, with a top edge 24 and a bottom edge 26. The actual construction of the overlay device 10 will be best appreciated with reference to FIG. 2.

In FIG. 2, it will be seen that the overlay device 10 includes a base member 28 that has an upper side 30 and a lower side 32. Both of the sides 30 and 32 have surfaces that are substantially flat and substantially parallel to each other. Further, the surfaces of sides 30 and 32 are separated from each other by a thickness 34 that is in a range between one half and three millimeters (0.5 mm-3 mm). As stated above, the sides 30 and 32 are preferably rectangular or square shaped, and they will have a distance 36 between the top edge 24 and the bottom edge 26 that is preferably around three inches. Thus, for a square shaped overlay device 10, the overall dimensions are approximately three inches by three inches (3 in.×3 in.). Preferably the base member 28 is made of a material such as a polypropylene or a polyester. In any event, it is important that the base member 28 be substantially transparent (i.e. clear or lightly tinted) so that a user can see through the base member 28. Also, as indicated above, the base member 28 needs to be flexible, just like all other components of the overlay device 10.

Still referring to FIG. 2 it will be seen that the overlay device 10 of the present invention includes an adhesive 38 that is affixed to the bottom side 32 of the base member 28. The adhesive 38 may be of any type well known in the pertinent art, such as a microsphere acrylic adhesive. Importantly, the adhesive 38, though permanently affixed to the surface of bottom side 32, must be able to hold onto a substratum (e.g. page 12), and able to be released from the substratum with a minimal application of force. Stated differently, the adhesive 38 that is used for the overlay device 10 of the present invention must allow the overlay device 10 to stick to a substratum (e.g. page 12) and to be removed from the substratum, without causing any observable damage or alteration to the substratum. Despite the type of adhesive 38 that is used, it is to be appreciated that the adhesive 38 can be affixed to either the entire side 32 of base member 28, or to selected portions of the side 32. For example, in FIGS. 1 and 2 it is implied that the adhesive 38 extends along the top edge 24, of the overlay device 10, between the side edges 20 and 22. With this particular location for the adhesive 38, it would be typical for the adhesive 38 to have a width 40 that extends from the top edge 24 through a range of approximately one quarter inch to approximately one half inch (¼ in.-½ in.). As will be understood by the skilled artisan, a protective strip (not shown) can be used to cover the adhesive 38 before the overlay device 10 is to be used. If so, in use, this protective strip needs to be peeled off to expose the adhesive 38.

As shown in FIG. 2, a clear coating 42 is used to cover the entire surface of the top side 30 of base member 28. Preferably, this coating 42 is a material such as acrylic, urethane, polyester or saran. Importantly, the coating 42 needs to be able to flex with the base member 28, and it also needs to be clear so that the user of overlay device 10 can see through the coating 42, as well as the base member 28. FIG. 2 also shows that the highlight markings 18a and 18b are placed directly onto the coating 42. Accordingly, it is important that the coating 42 be interactive with whatever liquid substance is used to make the highlight markings 18. As envisioned for the present invention this liquid substance will be applied by an instrument such as a highlight marker 44 (see FIG. 3), and will be a quick drying fluid, such as a translucent, colored ink of a type well known in the pertinent art. Also, though colored to allow the highlight markings 18 to contrast with underlying material, a user should be able to see through the markings 18. Further, it is important that the coating 42 be interactive with the dried residue of the liquid substance, because it is this residue that effectively constitutes the highlight markings 18. Specifically, this interaction should be such that the highlight markings 18 do not smear or otherwise unintentionally depart from the location(s) at which they are placed on the coating 42.

In the operation of the overlay device 10 of the present invention, the user first removes the protective strip (not shown) from the adhesive 38, if one is incorporated. With the adhesive 38 exposed, the user then positions the overlay device 10 on a page 12 as desired. To do this, the adhesive 38 is pressed against the page 12 to hold the overlay device 10 against the page 12. Once the overlay device 10 has been positioned on the page 12, the coating 42 is presented to the user, who then uses a marker 44 to place highlight markings 18 on the coating 42, as desired. For purposes of the present invention, this allows the markings 18 to highlight certain underlying textual material 16 for future reference by the user. The overlay device 10, with the highlight markings 18 can then be left in place on page 12 for as long as desired by the user. When the highlight markings 18 are no longer needed, the user merely lifts the overlay device 10 from the page 12 to remove the overlay device 10 from the book 14. The highlight markings 18 can then be erased from the overlay device 10 for further use of the overlay device 10, or the overlay device 10 may be discarded.

While the particular Repositional Write-On Transparency as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A device for temporarily highlighting certain informational markings on a substratum which comprises:
a substantially clear, flat base member having a first side and a second side;
an adhesive affixed to at least a portion of said second side of said base member for temporarily holding said base member against the substratum; and
a means for depositing a liquid substance over selected portions of said first side of said base member to highlight the certain informational markings when said base member is held against the substratum.

2. A device as recited in claim 1 further comprising a substantially clear coating applied on said first side of said base member, said coating being interactive with the liquid substance to dry the liquid substance and retain a residue thereof over the selected portions of said first side.

3. A device as recited in claim 2 wherein said coating is made of a material selected from a group consisting of acrylic, urethane, polyester and saran.

4. A device as recited in claim 1 wherein said first side of said base member is a substantially flat surface and said second side of said base member is a substantially flat surface with a thickness therebetween, wherein said first side is substantially parallel to said second side with dimensions greater than approximately three inches by three inches (3 in.×3 in.), and further wherein said thickness is in a range between one half and three millimeters (0.5 mm-3 mm).

5. A device as recited in claim 4 wherein said base member is made of a material selected from a group consisting of polypropylene and polyester.

6. A device as recited in claim 1 wherein said adhesive extends across said second side of said base member and has a width in a range of approximately one quarter inch to one half inch (¼ in.-½ in.).

7. A device as recited in claim 6 wherein said adhesive is a microsphere acrylic adhesive.

8. A device as recited in claim 1 wherein the liquid substance is a translucent colored ink.

9. A device as recited in claim 1 wherein the substratum is a page in a book and the informational markings are text.

10. A method for temporarily highlighting certain informational markings on a substratum which comprises the steps of:
providing an overlay comprising a substantially clear, flat base member having a first side and a second side, with an adhesive affixed to at least a portion of said second side and a substantially clear coating applied on said first side thereof;
engaging the adhesive on said base member with said substratum to temporarily hold said overlay against the substratum; and
depositing a liquid substance over selected portions of the coating, said coating being interactive with the liquid substance to dry the liquid substance and retain a residue thereof on the selected portions to highlight the certain informational markings when said base member is held against the substratum.

11. A method as recited in claim 10 further comprising the step of removing said overlay from the substratum, as desired.

12. A method as recited in claim 10 wherein said coating is made of a material selected from a group consisting of acrylic, urethane, polyester and saran.

13. A method as recited in claim 10 wherein said base member is made of a material selected from a group consisting of polypropylene and polyester.

14. A method as recited in claim 10 wherein said adhesive is a microsphere acrylic adhesive.

15. A method as recited in claim 10 wherein the liquid substance is a translucent colored ink.

16. A method as recited in claim 10 wherein the substratum is a page in a book and the informational markings are text.
